(19) United States
(12) Patent Application Publication
(10) Pub. No.: US 2017/0118996 A1
(43) Pub. Date: May 4, 2017

(54) BROAD SPECTRUM PEST REPELLENT COMPOSITIONS AND PEST MANAGEMENT SYSTEM

(71) Applicants: James J. Messina, Long Valley, NJ (US); James D. Messina, Washington, NJ (US)

(72) Inventors: James J. Messina, Long Valley, NJ (US); James D. Messina, Washington, NJ (US)

(21) Appl. No.: 15/403,336

(22) Filed: Jan. 11, 2017

Related U.S. Application Data
(63) Continuation of application No. 14/465,309, filed on Aug. 21, 2014.
Application No. 14/465,309 is a division of application No. 13/697,751, filed on Mar. 6, 2013, now abandoned.
(60) Provisional application No. 61/334,788, filed on May 14, 2010.
(60) Provisional application No. 61/421,297, filed on Dec. 9, 2010.
(60) Provisional application No. 61/437,042, filed on Jan. 28, 2011.

(51) Int. Cl. A01N 65/22; A01N 61/02; A01N 65/18; A01N 49/00

(52) U.S. Cl. CPC A01N 65/22; A01N 49/00; A01N 61/02; A01N 65/18

(57) ABSTRACT

The present invention provides compositions and methods for the control and management of wildlife populations (including domesticated animals) and pests such as birds including geese, deer and other herbivore such as rabbits, ground hogs, raccoons, moose and elk, tunneling animals such as moles, voles and gophers and insects, carnivores and other organisms. Specifically provided are geraniol oil-based formulations which may be applied to natural or artificial surfaces. Also provided are pest control systems incorporating the use of repellent or attractant formulations.

### CROSS REFERENCE TO RELATED APPLICATIONS

This application is a continuation of U.S. application Ser. No. 14/465,309 filed Aug. 21, 2014, entitled “BROAD SPECTRUM PEST REPELLENT COMPOSITIONS AND PEST MANAGEMENT SYSTEM,” which is a divisional of U.S. application Ser. No. 13/697,751 filed Mar. 6, 2013, which is a 371 US National Phase Application of Patent Cooperation Treaty International Application No. PCT/US2011/031901 filed Apr. 11, 2011, which claims the benefit of priority of U.S. Provisional Application No. 61/334,788 filed May 14, 2010, U.S. Provisional Application No. 61/421,297 filed Dec. 9, 2010, and U.S. Provisional Application No. 61/437,042 filed Jan. 28, 2011, the contents of each of which are herein incorporated by reference in their entirety.

### FIELD OF THE INVENTION

The invention relates to an animal and/or insect repellent and, in particular, to broad spectrum repellent compositions which will repel a variety of pests and which can be applied to a wide range of surfaces and substrates. Methods of use and a pest management system are also disclosed.

### BACKGROUND OF THE INVENTION

The encroachment of human habitation on heretofore rural areas has exacerbated existing problems of pest control. In recent years suburban backyards and public green spaces have been invaded by exploding deer populations and fowl who take up residence on ponds and in public areas near water fouling the surface or surrounding land area. Insect pests are also becoming more prevalent in suburban and rural areas.

Synthetic and often toxic chemical control means have long been used to manage pest movement and populations. However, with increasing public awareness of health issues regarding the impact on humans and the environment exposed to such chemical compounds, much effort has been expended in the identification of more benign and natural control measures.

To this end, legislative steps have been taken to categorize certain natural compounds as safe for use and hence exempt from certain government regulations. Such ingredients qualifying for Federal Insecticide, Fungicide, and Rodenticide Act (FIFRA) exemption include castor oil (U.S.P. or equivalent), linseed oil, cedar oil, malic acid, cinnamon and cinnamon oil, mint and mint oil, citric acid, peppermint and peppermint oil, citronella and citronella oil, 2-Phenethyl propionate (2-phenylethyl propionate), cloves and clove oil, potassium sorbate, corn gluten meal, putrescent whole egg solids, corn oil, rosemary and rosemary oil, cottonseed oil, sesame (includes ground sesame plant) and sesame oil, dried blood, sodium chloride (common salt), eugenol, sodium lauryl sulfate, garlic and garlic oil, soybean oil, geraniol, thyme and thyme oil, geranium oil, white pepper, sodium lauryl sulfate, zinc metal strips (consisting solely of zinc metal and impurities) and lemongrass oil.

Despite the strong incentive to develop natural and safe pesticides and animal repellents, there remains a long-felt need for compositions that are as effective (or more effective) than the chemical toxins currently in use to mitigate the economic and health impact of pests on humans.

### SUMMARY OF THE INVENTION

The present invention provides non-toxic geraniol oil-based compositions for use as single- or multi-species (broad spectrum) animal and/or insect repellents. The present invention also provides for the use of non-toxic compositions as single- or multi-species (broad spectrum) animal and/or insect attractants in combination with the pest management systems (PMSs) disclosed herein. Further aspects of the invention include the application of the formulations of the invention by contacting or impregnation to one or more substrates or surfaces. The formulations of the present invention provide further advantages in that most comprise only natural ingredients or ingredients not requiring EPA approval making then useful for application by homeowners and non-licensed applicators as well as for professional use.

In one embodiment, the present invention provides binary repellent compositions which comprise geraniol oil. In another embodiment, the invention provides ternary repellent compositions which comprise geraniol oil and either mint or castor oil alone or in combination with other ingredients. In one embodiment, the present invention provides a repellent composition comprising: (a) about 0.05 to about 30 weight percent of geraniol oil; (b) about 0.05 to about 15 weight percent of mint oil; (c) about 0.2 to about 35 weight percent of castor oil; (d) about 0.002 to about 9.3 weight percent of sodium lauryl sulfate; (e) about 0.01 to about 10 weight percent of kaolin; (0 about 0.1 to about 7.5 weight percent of xanthan gum; and (g) about 55 to about 95.6 weight percent of water. As such the repellent compositions may be formulated as an aqueous solution or mixture or as a concentrate.

In one embodiment, the present invention provides a repellent composition comprising (a) about 3 to about 25 weight percent of geraniol oil; (b) about 0.1 to about 8.5 weight percent of mint oil; (c) about 0.75 to about 20.5 weight percent of castor oil; (d) about 0.005 to about 6.5 weight percent of sodium lauryl sulfate; (e) about 0.03 to about 5 weight percent of kaolin; (0 about 0.5 to about 4.5 weight percent of xanthan gum; and (g) about 60 to about 93 weight percent of water.

In another embodiment the repellent composition comprises (a) about 5 to about 20 weight percent of geraniol oil; (b) about 0.3 to about 5.5 weight percent of mint oil; (c) about 2.1 to about 7.2 weight percent of castor oil; (d) about 0.01 to about 1 weight percent of sodium lauryl sulfate; (e) about 0.05 to about 2 weight percent of kaolin; (f) about 0.1 to about 2.3 weight percent of xanthan gum; and (g) about 65 to about 91 weight percent of water.

The repellent compositions may be diluted with water at a ratio of from 1 to 34 parts water, from 5 to 25 parts water or from 10 to 15 parts water. The water may be selected from the group consisting of ionized, distilled, filtered, spring, purified, mineral, sterile, well, artesian, fluorinated and a mixture thereof. They may also comprise one or more carriers, surface-active agents, thickeners, preservatives, aromatics, or adjuvants. Carriers may be selected from the group consisting of bentonite, fullers earth, additional clays, talc, chalk, quartz, attapulgite, montmorillonite or diatomaceous earth, vermiculite, highly dispersed silicic acid, alumina and silicates, calcite, marble, pumice, sepiolite and dolomite, inorganic and organic meals, sawdust, coconut shells, corn cobs and tobacco stalks.

Surface-active agents useful in the present compositions may be selected from the group consisting of polyethylene oxide esters of fatty acids, polyethylene oxide ethers of fatty alcohols, alkyl sulfates, alkyl sulfonates, aryl sulfonates, albumin hydrolyzates, and especially alkyl arylpolyglycol ethers, magnesium stearate, sodium oleate, lignin, sulfite waste liquors and methyl cellulose.

Thickeners useful in the present invention may be selected from the group consisting of agar, corn starch, potato starch and guar gum.

Adjuvants useful in the present invention may be selected from the group consisting of wetting agents, spreading agents, surfactants, sticking agents, adhesives, foam retardants, buffers, acidifiers, colorants and stabilizers.

The repellent compositions of the present invention may be applied via painting, brushing, mopping, spreading, banding, broadcasting, side-dressing, coating, rolling, bathing, dipping, immersing, soaking, adhering, sticking, rubbing, wiping, impregnating, injecting, embedding, sealing, stippling, dotting, dabbing, stenciling, stamping, layering, spackling, sprinkling, aerosolizing, misting, dusting, fumigation, aerial application, vaporizing, pouring and combinations thereof. The term aerial application includes, but is not limited to, distribution from an aircraft.

The present invention further provides for a pest control management system or “pest management system” or “PMS.” In this system, a repellent (or attractant) formulation is incorporated into a device which resembles, is disguised as, or is already an integral part of its environment. In one embodiment, the present invention provides for the use of non-toxic compositions to attract and trap animals and/or insects in combination with the Pest Management Systems (PMS) described.

In one embodiment, the pest management system device resembles a potter for plants. Other embodiments are devices that resemble plant pot saucers, vases, door jams, wood molding for placement in corners, bottles, food containers, food items, books, deck of cards, rocks, logs, articles of clothing, and outdoor camping equipment. In a further embodiment, the formulations of the present invention are used in outdoor settings and derive their disguise by being inserted or integrated into or onto objects found in the particular environment. For example, campers may carry the repellent compositions of the present invention with them and place packets or containers under rocks or other natural objects, insert them into hollowed out logs or in knots in trees, and the like. In this embodiment, it is beneficial but not necessary that the packet material in which the repellent is held be biodegradable.

### BRIEF DESCRIPTION OF THE DRAWINGS

The foregoing and other objects, features and advantages of the invention will be apparent from the following more particular description of the embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a side view of a plant pot pest management system 10 of the invention.

FIG. 2 is a side view of a saucer pest management system 20 of the invention.

### DETAILED DESCRIPTION OF THE INVENTION

The present invention provides compositions for use as single- or multi-species (broad spectrum) that alter the movement of animals and/or insects. As such, the present invention is directed to geraniol oil-based compositions for use as single- or multi-species (broad spectrum) animal and/or insect repellents. In combination with the pest management systems described herein, the invention also embraces the use of attractants. Further aspects of the invention include the application of the formulations of the invention by contacting or impregnation to one or more substrates or surfaces. The formulations of the present invention provide further advantages in that most comprise only natural ingredients or ingredients not requiring EPA approval making then useful for application by homeowners and non-licensed applicators as well as for professional use.

A “repellent” as used herein is any composition or formulation that makes unattractive to pests a habitat, food source or other site ordinarily sought or frequented. The term “pest” is intended to include living organisms that occur where they are not wanted or that cause damage to crops or food or turf or humans or other animals. Examples of pests include insects, mice and other animals, unwanted plants (weeds), fungi, microorganisms such as bacteria and viruses, and prions.

An “attractant” as used herein is any composition or formulation that makes attractive to pests a habitat, food source or other site which may be frequented or traversed by the pests.

“Alter the movement” as used herein refers to the ability of a formulation to change the mobility or direction of a pest (an animal and/or insect). For example, a repellent formulation applied to a plant pot may “alter the movement” of such insects by making a region of application near the plant pot unattractive to the insects and prevent the insects from approaching the food source within the plant pot.

Specifically, it has been discovered that the combination of one or more essential oils with one or more herb oils provide superior animal and/or insect repellent properties. As such, the components of the repellent compositions of the present invention function in a synergistic manner to provide multiple layers of repulsion. The repulsive effect is broad spectrum with regard to the number of animal and/or insect species repelled thus avoiding the necessity of applying multiple compositions to repel various animal pests, hence the compositions and their formulations broad spectrum repellents. “Broad spectrum,” as used in the context of a repellent, means that the repellent possesses activity against multiple species of animals, insects and/or organisms.

As used herein, an “essential oil” is any hydrophobic liquid containing volatile aromatic compounds from plants. They are also known as volatile or ethereal oils, or simply as the “oil of” the plant material from which they were extracted, such as oil of clove. The term “essential” indicates that the oil carries distinctive scent (essence) of the plant. Essential oils are typically extracted by distillation and hence may be concentrated. Other processes include expression and solvent extraction. Essential oils may include sub-categories of oils such as “herb oils” and “mint oils”. Among essential oils are eucalyptus oil and castor oil. The essential oils also include mint oil, jasmine oil, camphor oil, hinoki oil, tohi oil, pomegranate oil, turpentine oil, cinnamon oil, bergamot oil, mandarin oil, calamus oil, pine oil, lavender oil, bay oil, clove oil, hiba oil, rose oil, lemon oil, thyme oil, peppermint oil, rose oil, sage oil, menthol, cineole, eugenol, citral, citronellal, borneol, linalool, geraniol, camphor, thymol, spilanthole, pinene, limonene, and terpene compounds.

The term “herb oil” as used herein refers to any of the oils derived from herbs. An “herb” is a plant lacking a permanent woody stem. Among the preferred herb oils are mint and geranium oils with geraniol oil being most preferred.

Certain repellent compositions of the present invention comprise geraniol oil, mint, castor oil, sodium lauryl sulfate, kaolin (clay), xanthan gum and water. The repellent compositions may optionally comprise further components including, but not limited to, carriers, thickeners, surface-active agents, preservatives, aromatics, deodorizers, antibacterial agents, antifungal agents, antimicrobial agents, biocide agents, sunscreen active and one or more of several types of adjuvant including, but not limited to, wetting agents, spreading agents, sticking agents, foam retardants, buffers and acidifiers. The term “antibacterial agents” refers to substances which may destroy or inhibit the growth of bacteria; “antifungal agents” refers to substances which may destroy or inhibit the growth of fungi; “antimicrobial agents” refers to substance which may kill or inhibit the growth of microorganisms and “biocide agents” refers to chemical substances or microorganisms which may be capable of destroying living organisms. As used herein, “sunscreen active” is an additive that may absorb or reflect some of the ultraviolet radiation from a surface exposed to sunlight. The repellent compositions of the present invention may also be formulated in a combination with commercially available pesticides or insecticides (natural or synthetic).

The repellent properties of the compositions of the present invention qualify them as pesticides. According to the Environmental Protection Agency (EPA) and as used herein a “pesticide” is any substance or mixture of substances intended for: preventing, destroying, repelling, or mitigating any pest. They also include any substance or mixture of substances intended for use as a plant regulator, defoliant, or desiccant.

Typically, the repellent compositions are prepared as a concentrate and diluted to application strength or admixed with the appropriate particulate matter when used.

Concentrates may be diluted with water or suitable solvent at the time of use or it may be in ready-to-use form whereby the formulation requires no further manipulation before use. The term “concentrate” is used herein to describe a repellent composition or formulation which is in condensed form. A concentrate of the present invention is not necessarily without the presence of any diluent, e.g. water. Hence, a concentrate may be in liquid, solid, or gel form. It may be impregnated in or mixed with another substance which allows for distribution into the environment such as in a humidifier, diffuser, candle or air freshener.

For all components of the repellent compositions or their formulations, values in increments of the smallest measured value (e.g., for geraniol oil, 0.05%) are embraced within the ranges specified. For example, the range from 0.05% to 30% embraces the weight percentages of 0.05%, 0.10%, 0.15% . . . 29.9%, 29.95% and 30%.

Further, as used throughout the specification the term “about” is defined as plus or minus 10% of the stated value.

Units of measure used herein embrace both standard units and metric units. It is to be understood that where repellent compositions are measured, formulated or packaged as liquids, the units may be in increments of ounces, cups, pints, quarts, gallons, barrels, or portions thereof. They may also be in increments of milliliters, cubic centimeters, deciliters, liters, cubic meter or portions thereof.

It is to be understood that where repellent compositions are measured, formulated or packaged as solids, the units may be in increments of ounces, pounds, tons, or portions thereof. They may also be in increments of milligrams, grams, kilograms, metric tons or portions thereof.

Coverage of a surface, substrate or particular area with the compositions of the invention may be expressed in inches, feet, square feet, yards, square yards, acres, square acres, or portions thereof. They may also be in increments of millimeters, square millimeters, centimeters, square centimeters, meters, square meters, hectares, kilometers, square kilometers or portions thereof. Conversion between the standard and metric systems is readily understood in the art and particularly by those of skill in the art. Therefore, the present invention which teaches formulations in weight percent and ratios for dilution of concentrate are not limited to any particular system of measurement. For example, while the instant examples may describe the use of a single system, the present invention is just as clear on the formulation of a quart of repellent composition as a liter of repellent composition.

Geraniol Oil

The repellent compositions and formulations thereof contain geraniol oil. While the compositions of the present invention are referred to as “geraniol-based” this designation is not intended to imply any specific quantity or proportion of geraniol. It is merely to convey that all of the compositions contain geraniol.

Geraniol, (3,7-dimethyl-2,6-octadien-1-ol; CAS Reg. No. 106-24-1; C₁₀H18O) is a clear to pale yellow monoterpenoid alcohol which exists as an oily liquid. It is insoluble in water, but soluble in most common organic solvents. It has a rose-like odor, for which it is commonly used in perfumes. It is the primary part of oil-of-rose and palmarosa oil. It also occurs in small quantities in Geranium, Lemon, Citronella, and many other essential oils. Geraniol may be derived directly from geranium plants engineered to produce larger amounts of geraniol or from lemon grass or other herbs. It is typically extracted from geranium oil through a refining process.

While geraniol is used in insect repellants or deterrents to repel mosquitoes, house flies, stable flies, horn flies, cockroaches, fire ants, fleas, gnats, dog ticks, lone star ticks, no-see-ums, mite, crickets, earwigs, silverfish and lice, it is not known to have bird or non-insect repellant functionalities.

Surprisingly, it has been discovered that geraniol oil, in combination with castor oil, and mint does indeed have both bird and non-insect repellent properties as well as the killing of some organisms including scales.

According to the present invention, geraniol oil is present in the compositions of the present invention from about 0.05% by weight to about 30% by weight. In one embodiment, geraniol is present in an amount from 3-25% by weight. In a further embodiment it is present in an amount by weight of from 5-20%. In addition, geraniol oil may be present in amounts between or bounded by those recited herein. For example, the weight percentages 0.05 to 1%, 2-3%, 20-30%, 3-10%, 15-25%, 5-10%, and 15-20% are within the scope of the invention.

Castor Oil

The geraniol-based repellent compositions of the present invention preferably include the essential oil, castor oil. Castor oil is a vegetable oil derived from the seed of the castor plant, Ricinus communis. Castor oil (CAS number 8001-79-4) is a colorless to very pale yellow liquid with mild or no odor or taste. It is a triglyceride in which approximately ninety percent of fatty acid chains are ricinoleic acid but which may comprise oleic and linoleic acids.

According to the present invention castor oil may be present in the compositions of the present invention from about 0.02% by weight to about 35% by weight. In one embodiment, castor oil is present in an amount from 0.75%-20.5% by weight. In a further embodiment it is present in an amount by weight of from 2.1-7.2%. In addition, castor oil may be present in amounts between or bounded by those recited herein. For example, the weight percentages 0.02 to 5%, 20-35%, 0.75-10%, 15-20.5%, 2.1-5%, and 3-7.2% are within the scope of the invention.

In one embodiment, triglycerides that comprise any combination of ricinoleic, oleic and/or linoleic acids may be substituted for, or mixed with, castor oil in the compositions of the invention.

In certain formulations of repellent, castor oil is an optional ingredient. For example, in applications designed to repel deer, rabbits, groundhogs and other herbivores, castor oil is optional.

### Mint Oil

Repellent formulations of the present invention may include one or more mint oils. Mint oil is derived from one or more of the approximately 25 species of plants in the genus Mentha or the many hundreds of varieties of flowering plants in the family Lamiaceae (Mint Family). Species within Mentha have a distribution across Europe, Africa, Asia, Australia, and North America. Several mint hybrids commonly occur. The most common and popular mints for cultivation are peppermint (Mentha piperita) and spearmint (Mentha spicata).

Mint oil is known as an insecticide for its ability to kill some common pests like wasps, hornets, ants and cockroaches. The duration and scope of effectiveness of mint oil may be increased by adding eucalyptus oil, citronella, soybean oil, neem oil, and/or Deet.

According to the present invention mint oil may be present in the geraniol-based compositions of the present invention from about 0.05% by weight to about 15% by weight. In one embodiment, mint oil is present in an amount from 0.1%-8.5% by weight. In a further embodiment it is present in an amount by weight of from 0.3-5.5%. In addition, mint oil may be present in amounts between or bounded by those recited herein. For example, the weight percentages 0.05 to 7%, 8-15%, 0.1-4%, 4-8.5%, 0.3-3%, and 3-5.5% are within the scope of the invention. Any of the known mint oils may be used in the compositions of the present invention. These include, but are not limited to, water mint, or marsh mint, corn mint, wild mint, japanese peppermint, field mint, pudina, asian mint, Australian mint, pennyroyal, bergamot mint, wrinkled-leaf mint, Dahurian Thyme, slender mint, forest mint, horse mint, Corsican mint, garden mint, spearmint, curly mint, apple mint, pineapple mint and gray mint.

In certain formulations of repellent, mint oil is an optional ingredient. For example, in applications designed to repel moles, mint oil is optional.

### Sodium Lauryl Sulfate

Sodium lauryl sulfate (SLS), (C₁₂H₂₅SO4·Na) is an anionic surfactant used in many cleaning and hygiene products. The molecule has a tail of 12 carbon atoms, attached to a sulfate group, giving the molecule the amphiphilic properties favorable in a detergent. SLS is a highly effective surfactant. As used herein, the term “surfactant” means any substance which reduces the surface tension of a liquid. Surfactants may act as detergents, wetting agents, emulsifiers, foaming agents, and dispersants. According to the present invention, SLS may be added to the repellent compositions as an adjuvant thereby improving the properties of the compositions or the ease of use of said compositions.

According to the present invention SLS may be present in the compositions of the present invention from about 0.002% by weight to about 9.3% by weight. In one embodiment, SLS is present in an amount from 0.005%-6.5% by weight. In a further embodiment it is present in an amount by weight of from 0.01-1%. In addition, SLS may be present in amounts between or bounded by those recited herein. For example, the weight percentages 0.002 to 5%, 5-9.3%, 0.005-3%, 3-6.5%, 0.01-0.5%, .1-5% and 0.5-1% are within the scope of the invention. In formulations which are granular or substantially dry in nature, SLS may not be necessary.

### Kaolin (Clay)

In its natural state kaolin is a white, soft powder consisting principally of the mineral kaolinite. It is commonly used in the manufacture of china (porcelain), paper, rubber and paints. When mixed with water in the range of 20 to 35 percent, it becomes plastic (i.e., it can be molded under pressure), and the shape is retained after the pressure is removed. With larger percentages of water, the kaolin forms a slurry, or watery (aqueous) suspension as kaolin is insoluble in water.

Modified kaolin is used in industry as a physical barrier-type crop protectant. In these formulations, it is sprayed on as a slurry, whereby the water evaporates, leaving a powdery film on the surfaces of leaves, stems, and fruit. The film acts to protect plants and deter insects. However, to be effective, the film must coat all parts of the fruit or plant.

In one embodiment of the present invention, kaolin is added to the repellent compositions to improve adherence properties. It is not necessary that the repellent compositions containing kaolin described herein entirely coat or cover all parts of the surfaces or substrates treated in order to be effective repellents.

According to the present invention kaolin when used is present in the compositions of the present invention from about 0.01% by weight to about 10% by weight. In one embodiment, kaolin is present in an amount from 0.03%-5% by weight. In a further embodiment it is present in an amount by weight of from 0.05-2%. In addition, kaolin may be present in amounts between or bounded by those recited herein. For example, the weight percentages 0.01 to 5%, 5-10%, 0.03-2%, 2-5%, 0.05-1%, and 1-2% are within the scope of the invention.

### Xanthan Gum

Xanthan gum is a polysaccharide traditionally used as a food additive. In the present invention, xanthan gum is used as a thickening agent. Xanthan gum is advantageous in liquid formulations but is not necessary in powder or other dry forms.

According to the present invention xanthan gum may be present in the compositions of the present invention from about 0.1% by weight to about 7.5% by weight. In one embodiment, than gum is present in an amount from 0.5%-4.5% by weight. In a further embodiment it is present in an amount by weight of from 0.1-2.3%. In addition, xanthan gum may be present in amounts between or bounded by those recited herein. For example, the weight percentages 0.1 to 3%, 3-7.5%, 0.5-2%, 2-4.5%, 0.1-1%, and 1-2.3% are within the scope of the invention.

### Repellent Formulations

The repellent compositions of the present invention may be formulated. A “formulation” as used herein is a combination of components prepared as per a formula. Formulations may be made for one or more particular applications or uses. The formulations of the present invention are also compositions while compositions may be formulated.

Formulations comprising the repellent compositions of the present invention may be prepared in any known manner, and may be in the form of liquid solutions (e.g., aqueous) or mixtures which are substantially dry. For instance, the repellent compositions may be mixed with conventional dispersible liquid diluents or carriers and/or dispersible solid carriers. They may be in the form of aqueous solutions, slurries or mixtures. The repellent composition can be mixed with carriers and the combination or just the repellent composition can be freeze-dried. As used herein, “freeze-dried” means a dehydration process used to preserve a material.

The pest management systems of the present invention may be used in combination with the repellent formulations of the invention or with attractants known in the art. Attractant formulations of the present invention may comprise of one or a combination of the following: sugar, honey, molasses, pheromones, plant oils, plant extracts, floral odors, proteins, salt, animal oils such as fish oil and the like, seeds, animal feed, livestock feed, and sticky agents, adhesives including substances such as tanglewood and the like. The attractant composition may be applied in the form of aerosol, balm, cream, gel, lotion, mousse, patch, pump spray, roll on, solution, gel stick, solid stick, towelette, salve, ointment, powder, liquid, granules, candle, vapor, beads and the like. As used herein, “towelette” means a moistened piece of paper or cloth or the like. It is known to those in the art that “towelette” can also be known as a “wet wipe.” A “patch”, as used herein, means at least one piece of material which may be affixed to a surface such as skin, fabric, shoes or the like.

Attractants include compositions and formulations such as those known to those skilled in the art and also disclosed in U.S. Patent Application Nos. 20100074860 and 20090258950, the contents of which are incorporated herein by references in their entirety.

Repellent formulations of the present invention may comprise as a binary base formulation which includes geraniol oil and one other ingredient. In one embodiment, the base formulation comprises geraniol oil from 0.05 to 30 percent by weight in combination with one or more mint oils from 0.05 to 15 percent by weight. According to the invention, binary base formulations may also comprise geraniol oil from 0.05 to 30 percent by weight in combination with castor oil from 0.2 to 35 percent by weight. In another embodiment, the binary base formulation may comprise geraniol oil from 2 to 30 percent by weight in combination with a surfactant from 0.1 to 5 weight percent. A further embodiment may comprise geraniol oil from 2 to 30 percent by weight in combination with mint oil from 0.5 to 6 percent by weight, sodium lauryl sulfate from 0.5 to 6 percent by weight wherein other ingredients added in the formulation may be selected from, but not limited to, a thickener, a binder, a gelling agent, a solvent and a vegetable oil. The binary repellent compositions may be applied in the form of aerosol, balm, cream, gel, lotion, mousse, patch, pump spray, roll on, solution, gel stick, solid stick, towelette, salve, ointment, powder, liquid, granules, candle, vapor, beads and the like. Certain nonlimiting examples of binary base formulations are shown in Table 1.

TABLE 1
Binary Base Repellent Formulations

| | Weight percent | Weight percent of |
|---|---|---|
| | of Component | Component |
| Component (CAS Reg. No) | Base Formulation 1 | Base Formulation 2 |
| Geraniol oil (106-24-1) | 0.05-30 | 0.05-30 |
| Mint oil | 0.05-15 | — |
| Castor oil (8001-79-4) | — | 0.2-35 |
| Other ingredients | 55-99.9 | 35-99.75 |

Further, ternary base formulations may be formed which include geraniol oil. In one embodiment, a ternary base formulation comprises geraniol oil, mint oil and castor oil. The tertiary repellent compositions may be applied in the form of aerosol, balm, cream, gel, lotion, mousse, patch, pump spray, roll on, solution, gel stick, solid stick, towelette, salve, ointment, powder, liquid, granules, candle, vapor, beads and the like.

TABLE 2
Repellent Formulations

| | Weight percent of |
|---|---|
| | Component |
| Component (CAS Reg. No) | Base Formulation 3 |
| Geraniol oil (106-24-1) | 0.05-30 |
| Mint oil | 0.05-15 |
| Castor oil (8001-79-4) | 0.2-35 |
| Other ingredients | 20-99.7 |

“Other ingredients” which may be added to the binary or ternary base formulations include, but are not limited to, ingredients which are disclosed herein or known to those skilled in the art. Other ingredients may also include milk, bitrex, thiram, methyl ammonium saccharide, thymol, garlic, garlic powder, garlic oil, capsaicin, hot pepper, white pepper, oil of black pepper, piperine, chemically formulated pepper, predator urines (large cat and carnivores), chemically formulated predator urines, urea, naphthalene (moth balls), pyrethrine, blood, blood meal, bone meal, sulfurous emitting items (eggs, sulfur, meats, etc), denatonium benzoate, ammonium of fatty acids, butyl mercaptan, clove, fish oil, onion, ammonia, mineral oil, orange oil, kelp (seaweed), whole eggs, powdered eggs, putrescent eggs, egg whites, egg yolks, rotten eggs, rosemary, wintergreen, 2-propenoic acid, potassium salt, 2-propeniamide, 2 phenethyl propionate, acetic acid, latex, animal glue, clay, formaldehyde, stickers like nufilm p and others in the series, and thyme.

It should be understood that the binary and ternary base formulations in Tables 1 and 2 may be formulated as liquid, solid or gel form and may be diluted or formulated as concentrates in liquid, solid or gel form.

As used herein the term “aqueous” means similar to or containing or dissolved in water, e.g., an aqueous solution. A “slurry” according to the present invention is a suspension of predominantly insoluble particles, usually in water. A “mixture” according to the present invention is a substance consisting of two or more substances mixed together.

Formulations may also be in the form of solid mixtures, whether in bulk, small particulate or dust form. As used herein, the term “particulate” means any solid in a subdivided state. Particulates are larger than dusts however dusts may be considered particulates. Particulates may be homogenous or heterogeneous. They may be granules or particles, organic or inorganic.

The compositions of the present invention may also be applied to a surface or substrate. As used herein a “surface” is the outer boundary of an object, a material layer constituting or resembling such a boundary or the extended two-dimensional outer boundary of a three-dimensional object, while a “substrate” is any stratum or layer lying underneath another. A substrate need not be laminar and may also comprise a solid carrier or particulate.

The compositions of the present invention may be optionally mixed with carrier vehicle assistants, e.g. conventional surface-active agents, including emulsifying agents and/or dispersing agents. Further, in the case where water is used as diluent, organic solvents may be added as auxiliary solvents. Suitable liquid diluents or carriers include water, petroleum distillates, or other liquid carriers with or without surface active agents. The choice of dispersing and emulsifying agents and the amount employed is dictated by the nature of the repellent composition and the ability of the agent to facilitate the dispersion of the repellent compositions. Non-ionic, anionic, amphoteric, or cationic dispersing and emulsifying agents may be employed.

Liquid repellent compositions may be prepared by dispersing a repellent concentrate formulation of the present invention in water or suitable solvent.

The concentrated formulation may be an aqueous solution, slurry or mixture (wet or dry), comprising multiple components that may be adjusted either in the preparation of the concentrate or during the final dilution step prior to use or application.

Table 3 illustrates three repellent concentrate formulations (compositions) of the present invention. The range of the amount of each component (in % by weight) is given. Where available and for reference, CAS Registry Numbers are provided. As used herein “CAS Registry Number” means the identifier assigned to a particular substance by Chemical Abstracts Service, a division of the American Chemical Society. The CAS Registry Number is not meant to be limiting and, where no number is provided, is not meant to suggest none exists.

TABLE 3
Repellent Concentrate Formulations

| | Weight percent of Component | | |
|---|---|---|---|
| | Formulation | | Formulation |
| Component (CAS Reg. No) | A | Formulation B | C |
| Geraniol oil (106-24-1) | 0.05-30 | 3-25 | 5-20 |
| Mint oil | 0.05-15 | 0.1-8.5 | 0.3-5.5 |
| Castor oil (8001-79-4) | 0.2-35 | 0.75-20.5 | 2.1-7.2 |
| Sodium lauryl sulfate | 0.002-9.3 | 0.005-6.5 | 0.01-1 |
| (151-21-3) | | | |
| Kaolin clay (1332-58-7) | 0.01-10 | 0.03-5 | 0.05-2 |
| Xanthan Gum (11138-66-2) | 0.1-7.5 | 0.5-4.5 | 0.1-2.3 |
| Water (7732-18-5) | 55-95.6 | 60-93.3 | 65-91 |

### Carriers

In addition to the components listed in the Tables above, the repellent compositions and formulations of the present invention may contain one or more carriers or carrier vehicles. As used herein a “carrier” is a substance that transmits, serves, or aids in transmission or acts as the medium for transmission. Carriers may be liquid or solid. They are most often inert but may be active ingredients.

Examples of conventional carrier vehicles include, but are not limited to, aerosol propellants which are gaseous at normal temperatures and pressures, such as freon; inert dispersible liquid diluent carriers, including inert organic solvents, such as aromatic hydrocarbons (e.g. benzene, toluene, xylene, alkyl naphthalenes, etc.), halogenated especially chlorinated, aromatic hydrocarbons (e.g. chloro-benzenes, etc.), cycloalkanes, (e.g. cyclohexane, etc.), paraffins (e.g. petroleum or mineral oil fractions), chlorinated aliphatic hydrocarbons (e.g. methylene chloride, chloroethylenes, etc.), alcohols (e.g. methanol, ethanol, propanol, butanol, glycol, etc.) as well as ethers and esters thereof (e.g. glycol monomethyl ether, etc.), amines (e.g. ethanolarnine, etc.), amides (e.g. dimethyl formamide etc.), sulfoxides (e.g. dimethyl sulfoxide, etc.), acetonitrile, ketones (e.g. acetone, methyl ethyl ketone, methyl isobutyl ketone, cyclohexanone, etc.), and/or water; as well as inert dispersible finely divided solid carriers such as ground natural minerals (e.g., vermiculite, alumina, silica, chalk, i.e. calcium carbonate, talc, attapulgite, montmorillonite, kieselguhr, etc.) and ground synthetic minerals (e.g. highly dispersed silicic acid, silicates, eg. alkali silicates, etc.).

The repellent compositions of the present invention may be admixtures with finely divided solids such as talc, attapulgite clay, kieselguhr, pyrophyllite, chalk, diatomaceous earth, vermiculite, calcium phosphates, calcium and magnesium carbonates, sulfur, flours, and other organic and inorganic solids which act as carriers. These finely divided solids, or dusts, preferably have an average particle size of less than about 50 microns. A typical dust formulation useful for controlling pests contains 1 part of pesticidal composition and 99 parts of diatomaceous earth or vermiculite. Granules may comprise porous or nonporous particles. The granule particles are relatively large, a diameter of about 400-2500 microns typically. The particles are either impregnated or coated with the inventive repellent compositions from solution. Granules generally contain 0.05-15%, preferably 0.5-5%, active ingredient as the pesticidally-effective amount. Thus, the repellent compositions of the present invention can be formulated with any of the following solid carriers or diluents such as bentonite, fullers earth, ground natural minerals, such as kaolins, clays, talc, chalk, quartz, attapulgite, montmorillonite or diatomaceous earth, vermiculite, and ground synthetic minerals, such as highly-dispersed silicic acid, alumina and silicates, crushed and fractionated natural rocks such as calcite, marble, pumice, sepiolite and dolomite, as well as synthetic granules of inorganic and organic meals, and granules of organic materials such as sawdust, coconut shells, corn cobs, tobacco stalks and other natural cast off products that may or may not be a by-product of manufacturing or harvest such as walnut or nut shells or egg shells.

### Surface-Active Agents

It may also be necessary to include one or more surface active agents. Surface-active agents,(i.e., conventional carrier vehicle assistants) that may be employed with the present invention include, without limitation, emulsifying agents, such as non-ionic and/or anionic emulsifying agents (e.g. polyethylene oxide esters of fatty acids, polyethylene oxide ethers of fatty alcohols, alkyl sulfates, alkyl sulfonates, aryl sulfonates, albumin hydrolyzates, and especially alkyl arylpolyglycol ethers, magnesium stearate, sodium oleate, etc.); and/or dispersing agents such as lignin, sulfite waste liquors, methyl cellulose, etc.

### Thickeners

One or more thickeners or thickening agents may be added to the compositions of the present invention. “Thickeners” are substances which, when added to a mixture (aqueous or otherwise), increase its viscosity without substantially modifying its other properties. Thickeners may be used to ensure uniform consistency. A starch, thickener, or gelling agent may also be used to alter the consistence of the repellent compositions of the present invention. Agar, corn starch, potato starch and guar gum or the like, may be used. These agents can also be added to keep the ingredients in suspension. Typically thickeners are added at about 0.1 to 5% of the total composition.

### Preservatives

Preservatives may be added to the compositions and formulations of the present invention. As used herein a “preservative” is any substance or compound that is added to protect against decay, decomposition or spoilage. Means of preservation may also be utilized. Preservatives may be natural or synthetic. They may be antimicrobial preservatives, which inhibit the growth of bacteria or fungi, including mold, or antioxidants such as oxygen absorbers, which inhibit the oxidation of food constituents. Common antimicrobial preservatives include calcium propionate, sodium nitrate, sodium nitrite, sulfites (sulfur dioxide, sodium bisulfite, potassium hydrogen sulfite, etc.) and disodium EDTA. Antioxidants include BHA and BHT. Other preservatives include formaldehyde (usually in solution), glutaraldehyde (kills insects), ethanol and methylchloroisothiazolinone. A preservative, such as potassium sorbate can be added to the compositions or formulations. Typically, preservatives appear in the compositions at between 0.03 to 3% by weight percent.

### Other Components

Optional components such as one or more dilute acids, other naturally occurring insecticides, sodium chloride and potassium soaps increase the range of activity of the base repellent composition with regard to the number of animal species repelled and the duration of the repulsive effect. Therefore, these may be added in suitable weight percent amounts. Other possible additives are perfumes, mineral or vegetable, optionally modified oils, waxes and nutrients (including trace nutrients), such as salts of iron, manganese, boron, copper, cobalt, molybdenum and zinc.

### Other Aromatics

The addition of cedar oil to the composition enhances the effectiveness of the composition as an animal repellent. It also adds ability to repel insects and kill mosquito larvae in water. Cedar oil may be added at between 0.03% and 10%. It may be added between 1% and 5%, between 2% and 4% or between 5% and 10%.

Camphor is a waxy, white or transparent solid with a strong, aromatic odor. It is a terpenoid with the chemical formula C₁₀ H₁₆ O. It is found in wood of the camphor laurel (Cinnamomum camphora), a large evergreen tree found in Asia (particularly in Borneo and Taiwan). It also occurs in some other related trees in the laurel family, notably Ocotea usambarensis. Camphor has been used as an insect repellent and may be added to the repellent compositions of the present invention in amounts of (by weigh percent) 0.01% to 15%. It may be added between 1% and 5%, between 2% and 4% or between 5% and 10%.

### Pyrithrin

An additional optional component is a natural insecticide such pyrithrin. The pyrethrins are a pair of natural organic compounds that have potent insecticidal activity. Pyrethrin I and pyrethrin II are structurally related esters with a cyclopropane core. They differ by the oxidation state of one carbon and exist as viscous liquids.

The pyrethrins are contained in the seed cases of the perennial plant pyrethrum (Chrysanthemum cinerariaefolium), which is grown commercially to supply the insecticide.

When present in amounts not fatal to insects in the present formulations, they have an insect repellent effect. They are harmful to fish, but are far less toxic to mammals and birds than many synthetic insecticides. Pyrithrins are non-persistent, biodegradable, break down easily on exposure to light or oxygen and are considered to be among the safest insecticides for use around food.

Among the synthetic analogs of pyrithrin is permethrin. It is a member of the pyrethroid family and functions as a neurotoxin, by prolonging sodium channel activation and is the preferred synthetic pyrethroid although other members may be utilized in the present invention. The pyrithrins may be added at between 0.001% and 10%. It may be added between 1% and 5%, between 2% and 4% or between 5% and 10%.

### Adjuvants

According to the present invention one or more adjuvants may be added to the repellent compositions. As used herein an “adjuvant” is a substance that aids, assists or improves one or more properties or activities of another substance.

Adjuvant categories include, but are not limited to, wetting agents and/or spreading agents (surfactants), sticking agents, adhesives, foam retardants, buffers, acidifiers, colorants, stabilizers and waterproofing agents.

Wetting/Spreading agents: A sprayed drop comprising an active agent, e.g., a repellent composition must be able to wet the surface and spread out or cover an area to perform its intended function. In some situations, a wetting agent (also known as a spreading agent or surfactant) is necessary for good coverage. A wetting agent/surfactant reduces the surface tension of the water on the surface of the spray drop and by reducing the interfacial tension between the spray drop and surface. This requires a surfactant that will preferentially aggregate at these surfaces. Surfactants wet and disperse particles of active ingredient(s) in the concentrate or upon dilution prior to spraying, and wet the target surface with the pesticide spray to achieve more effective coverage of the target. Concentrated multipurpose wetting agents typically contain a blend of bio-degradable, non-ionic surfactants and an emulsified silicone type anti-foam preparation. This action provides uniform wetting and coverage. Exemplary surfactants include amphoteric/zwitterionic surfactants; anionic surfactants; nonionic surfactants; cationic surfactants. Amphoteric surfactants useful in the invention can be described as a surface active agent containing at least one anionic and one cationic group and can act as either acids or bases depending on pH. Some of these compounds are aliphatic derivatives of heterocyclic secondary and tertiary amines in which the aliphatic radical may be straight or branched and wherein one of the aliphatic substituents contains from about 6 to about 20, preferably 8 to 18, carbon atoms and at least one contains an anionic water-solubilizing group, e.g., carboxy, phosphonate, phosphate, sulfonate, sulfate.

Zwitterionic surfactants can be described as surface active agents having a positive and negative charge in the same molecule which molecule is zwitterionic at all pH's. Zwitterionic surfactants can be best illustrated by betaines and sultaines. The zwitterionic compounds generally contain a quaternary ammonium, quaternary phosphonium or a tertiary sulfonium moiety. In all of these compounds there is at least one aliphatic group, straight chain or branched, containing from about 6 to 20, preferably 8 to 18, carbon atoms and at least one aliphatic substituent containing an anionic water-solubilizing group, e.g., carboxy, sulfonate, sulfate, phosphate or phosphonate. Examples of suitable amphoteric and zwitterionic surfactants include the alkali metal, alkaline earth metal, ammonium or substituted ammonium salts of alkyl amphocarboxyglycinates and alkyl amphocarboxypropionates, alkyl amphodipropionates, alkyl monoacetate, alkyl diacetates, alkyl amphoglycinates, and alkyl amphopropionates wherein alkyl represents an alkyl group having from 6 to about 20 carbon atoms. Other suitable surfactants include alkyliminomonoacetates, alkyliminidiacetates, alkyliminopropionates, alkyliminidipropionates, and alkylamphopropylsulfonates having between 12 and 18 carbon atoms, alkyl betaines and alkylamidoalkylene betaines and alklyl sultaines and alkylamidoalkylenehydroxy sulfonates. Anionic surfactants which may be used in the present invention are those surfactant compounds which contain a long chain hydrocarbon hydrophobic group in their molecular structure and a hydrophilic group, including salts such as carboxylate, sulfonate, sulfate or phosphate groups. The salts may be sodium, potassium, calcium, magnesium, barium, iron, ammonium and amine salts of such surfactants.

Anionic surfactants include the alkali metal, ammonium and alkanol ammonium salts of organic sulfuric reaction products having in their molecular structure an alkyl, or alkaryl group containing from 8 to 22 carbon atoms and a sulfonic or sulfuric acid ester group. Examples of such anionic surfactants include water soluble salts and mixtures of salts of alkyl benzene sulfonates having between 8 and 22 carbon atoms in the allyl group, alkyl ether sulfates having between about 8 and about 22 carbon atoms in the alkyl group and about 2 to about 9 moles ethylene oxide in the ether group. Other anionic surfactants that can be mentioned include alkyl sulfosuccinates, alkyl ether sulfosuccinates, olefin sulfonates, alkyl sarcosinates, alkyl monoglyceride sulfates and ether sulfates, alkyl ether carboxylates, paraffinic sulfonates, mono and dialkyl phosphate esters and ethoxylated derivatives, acyl methyl taurates, fatty acid soaps, collagen hydrosylate derivatives, sulfoacetates, acyl lactates, aryloxide disulfonates, sulfosuccinamides, naphthalene-formaldehyde condensates and the like. Aryl groups generally include one and two rings, alkyl generally includes from 8 to 22 carbon atoms and the ether groups generally range from 1 to 9 moles of ethylene oxide (EO) and/or propylene oxide (PO), preferably EO. Specific anionic surfactants which may be selected include linear alkyl benzene sulfonates such as decylbenzene sulfonate, undecylbenzene sulfonate, dodecylbenzene sulfonate, tridecylbenzene sulfonate, nonylbenzene sulfate and the sodium, potassium, ammonium, triethanol ammonium and isopropyl ammonium salts thereof.

The nonionic surfactant(s) may be any of the known nonionic surfactants which are generally selected on the basis of compatibility, effectiveness and economy. Examples of useful nonionic surfactants include condensates of ethylene oxide with a hydrophobic moiety. The surfactants include the ethoxylated primary or secondary aliphatic alcohols having from about 8 to about 24 carbon atoms, in either straight or branch chain configuration, with from about 2 to about 40, and preferably between about 2 and about 9 moles of ethylene oxide per mole of alcohol. Other suitable nonionic surfactants include the condensation products of from about 6 to about 12 carbon atoms alkyl phenols with about 3 to about 30, and preferably between about 5 to about 14 moles of ethylene oxide. Many cationic surfactants are known in the art and almost any cationic surfactant having at least one long chain allyl group of about 10 to 24 carbon atoms is suitable for optional use in the present invention.

Sticking agents: A sticking agent can perform three types of functions. It can increase the adhesion or “stickiness” of solid particles that otherwise might be easily dislodged from a surface. It can also reduce evaporation of the formulation. The third function can be to provide a waterproof coating. If the sticking agent is not water soluble, it can provide a degree of protection from this form of loss.

Many of the sticking agents contain surfactants as their principal functioning agent and give both a sticking action and a wetter-spreader action. These will perform the first two functions quite well. But since the surfactants that provide wetter-spreader action must be somewhat water soluble, they may not provide good protection from rain. This will be provided by products that contain natural resins (rosin), or other waterproofing agents. Sticking-spreaders can be made of many different components, organic or inorganic. Some are silicone-based surfactants, oils, emulsifiers and buffering agents, while others may contain combinations such as fish oil or fatty acid soaps or emulsified soybean oil. Sticking agents include tackifiers. Tackifiers such as carboxymethylcellulose and natural and synthetic polymers in the form of powders, granules or latices, such as gum arabic, polyvinyl alcohol and polyvinyl acetate, as well as natural phospholipids such as cephalins and lecithins, and synthetic phospholipids, can be used in the formulations.

Adhesives: Adhesives, such as carboxymethyl cellulose, natural and synthetic polymers, (such as gum arabic, polyvinyl alcohol and polyvinyl acetate), and the like, may also be used in the formulations in the form of powders, granules or emulsifiable concentrations.

Foam retardants: Some formulations will create foam in spray tanks as a result of both the surfactants used in the concentrate formulation and the type of spray tank agitation. This foam can be reduced or eliminated by a small amount of foam inhibitor.

Oil based defoamers have an oil carrier. The oil might be mineral oil, vegetable oil, white oil or any other oil that is insoluble in the foaming medium, except silicone oil. An oil based defoamer also contains a wax and/or hydrophobic silica to boost the performance. Typical waxes are ethylene bis stearamide (EBS), paraffinic waxes, ester waxes and fatty alcohol waxes. These products might also have surfactants to improve emulsification and spreading in the foaming medium.

Water based defoamers are different types of oils and waxes dispersed in a water base. The oils are often white oils or vegetable oils and the waxes are long chain fatty alcohol, fatty acid soaps or esters. These are normally best as deaerators, which mean they are best at releasing entrained air.

Silicone-based defoamers have a silicone compound as the active component. These might be delivered as oil or a water based emulsion. The silicone compound consists of an hydrophobic silica dispersed in a silicone oil. Emulsifiers are added to ensure that the silicone spreads fast and well in the foaming medium. The silicone compound might also contain silicone glycols and other modified silicone fluids.

EO/PO based defoamers contain polyethylene glycol and polypropylene glycol copolymers. They are delivered as oils, water solutions, or water based emulsions. EO/PO copolymers normally have good dispersing properties and are often well suited when deposit problems are an issue.

Alkyl polyacrylates are suitable for use as defoamers in non-aqueous systems where air release is more important than the breakdown of surface foam. These defoamers are often delivered in a solvent carrier like petroleum distillates.

Foam retardants or defoamers may be used in the compositions of the present invention between 0.5% and 10% by weight.

Buffers: Some water used for diluting formulations is alkaline (high pH). If the pH is sufficiently high and the pesticide is subject to degradation by alkaline hydrolysis, it may be necessary to lower the pH of the mix water to a pH in the range of 3 to 7, preferably 3.75 to 4.25. Buffers containing phosphoric acid or a salt of phosphoric acid, will lower the pH of the water and tend to stabilize the pH at an acceptable value. The efficacy of the buffer depends on its concentration of phosphoric acid and the degree of alkalinity or “hardness” of the mixing water that is being neutralized. The more alkaline the water, the greater the amount of buffer required.

Some buffers have sufficient surfactant present to also perform as wetter-spreaders. The concentration of surfactant and phosphoric acid are usually lumped together and it is not possible to determine the concentration of either and thus predict their efficacy. A useful range for phosphoric acid buffer concentration is from about 2 to 10%.

Acidifiers: Buffers that acidify alkaline spray waters increase the effectiveness. Buffers can help increase the residual life of the formulation about two-fold and can result in reducing the number of spray applications per season. Muriatic acid, Buffer-X or vinegar are not effective for this purpose. The duration and scope of effectiveness of the present invention may also be increased by adding a dilute acid to the composition, especially acetic acid, which may be in the form of vinegar, preferably white distilled vinegar having an acid content of between 3.5 and 5% acetic acid.

Colorants: It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc. Colorants are advantageous when it is important for the repellent compositions or formulations when applied to blend in, or be less detectable in the environment applied. This advantage is sometimes aesthetic but can serve a functional role where pests are likely to either be attracted or repelled based on color.

The use of these adjuvants provides a variety of benefits including improved coverage of the spray both in the soil and on plant surfaces, increased retention on surfaces, reduced evaporation, reduced foaming problems in the tank, easier sprayer cleaning and lubrication of pump and sprayer nozzles.

Stabilizers: Stabilizers, such as low-temperature stabilizers, preservatives, antioxidants, light stabilizers or other agents which improve chemical and/or physical stability may also be present. Stabilizers are useful to inhibit the reaction between two or more other chemicals. They can also inhibit separation of suspensions, emulsions, and foams.

### Applications and Methods

The repellent compositions may be applied to any surface or substrate by any convenient method. It is expected that spraying will be the application method of choice in most circumstances where a liquid formulation is used. For example, an aircraft may be used to spray the liquid formulation over crops or fields. Other methods of application contemplated include, but are not limited to, painting, brushing, mopping, spreading, banding, broadcasting, side-dressing, coating, rolling, bathing, dipping, immersing, soaking, adhering, sticking, rubbing, wiping, impregnating, injecting, embedding, sealing, stippling, dotting, dabbing, stenciling, stamping, layering, spackling, sprinkling, aerosolizing, misting, dusting, vaporizing, pouring and the like. Methods of application may also be indirect. For example, containers or vessels holding an amount of a repellent composition may be placed in an area to be treated with dispersion of the composition being effected by forces of nature, e.g., wind, rain, current, radiant heat. Air spraying apparatuses may be employed such as those disclosed in U.S. Pat. No. 4,172,557, the contents of which are incorporated herein in its entirety. Dispersion may also be effected from a container whereby dispersion is activated by movement such as a motion sensor. Aerosol dispersion is particularly amenable to automatic release via motion detection. Indirect methods also include the use of mechanical devices to effect the applications listed herein. For example, timed spreaders or broadcasters may be set up in predetermined areas in order to apply or disperse the repellents to a surface, area or substrate in a temporal fashion, e.g., automated application. Triggering of timed spreaders or timed distribution may be predetermined or may occur on signal either remotely initiated or initiated as part of a timed sequence after a detection event. For example, application of the repellent may occur at a time after trigger by a motion detector of the presence of a pest.

Indirect methods also include the use of devices such as those disclosed in U.S. Pat. No. 6,192,621, the contents of which are incorporated herein by reference in their entirety. In this application, the animal repellents, alone or in combination with other agents or repellents are installed in the animal control device capable of repelling or attracting pests to any area in which the device is placed.

### Pest Management Systems

The present invention provides for pest management systems which may incorporate the repellent compositions of the present invention. It is also envisioned that these systems may also be used in conjunction with commercially available attractants and as such represent a means to attract and trap pests.

The advantages of such a disguised trapping system include ease of use and a more acceptable presence. As such, they would be superior to unattractive traps and consequently be used more often which would, by definition, result in more trapped pests.

The pest management systems of the invention comprises a composition housing, and a variable housing which together form the body of the pest management system. The composition housing and variable housing are separated by an interface. The interface may be a complete barrier, a partial barrier or in intermittent barrier. It may comprise a wall, or screen and its surface may be of any shape including, but not limited to, flat, convex, concave, oval, round, irregular, etc. The composition housing further comprises one or more ports. Ports, among other things, provide for ingress or egress of animals or pests as well as for the release of the repellent or attractant composition odors.

Multiple pest management systems may be combined.

The body of the system may be the only portion which is disguised. The variable housing may be the only portion of the system which is disguised. The composition housing may be the only portion of the system which is disguised.

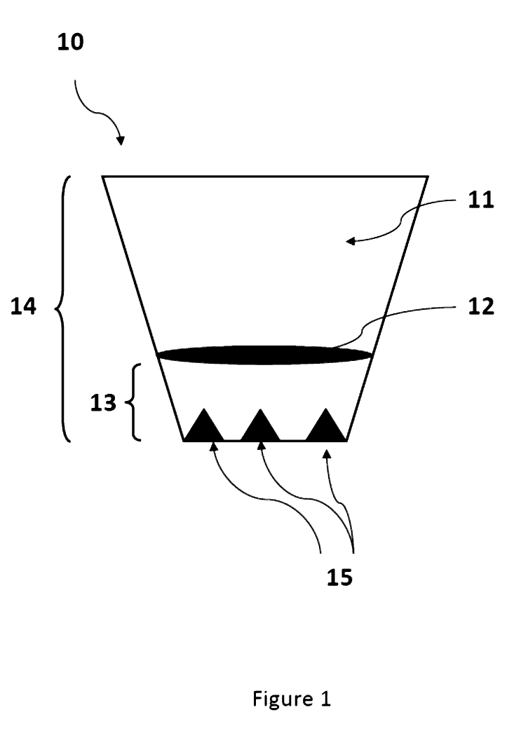

FIG. 1 illustrates a plant pot pest management system 10 of the invention. The plant pot pest management system 10 comprises a body 14 comprising a composition housing 13, a variable housing 11, an interface 12 that separates the two housings. In this embodiment, the interface is a false bottom in the pot. Ports 15, are found in the composition housing and may be of any shape or size.

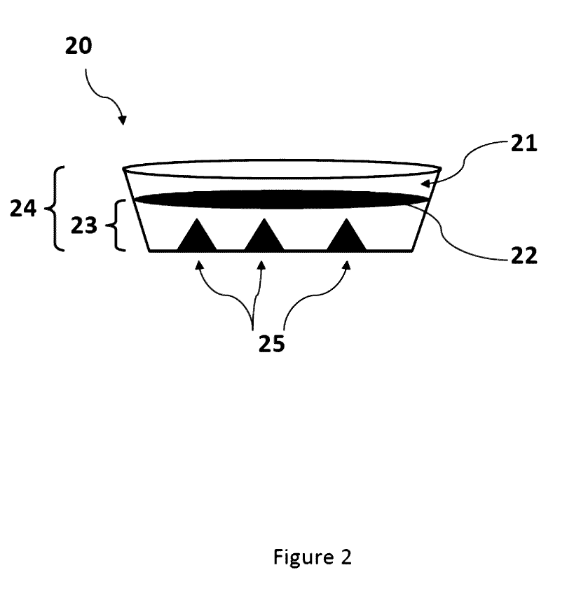

FIG. 2 illustrates a saucer pest management system 20 of the invention. The saucer pest management system 20 comprises a body 24 comprising a composition housing 23, a variable housing 21, an interface 22 that separates the two housings. In this embodiment, the interface is a false bottom in the saucer. Ports 25, are found in the composition housing and may be of any shape or size.

The pest management systems of FIGS. 1 and 2 may be used alone or in combination with one another.

The system may be an item where a formulation is applied to an already existing item. For example, a repellent formulation may be applied to the outer surface of a food container, such as cooler, and placed outdoors to prevent animals and/or insects from approaching the container.

In another embodiment, a pest management system is an item where a cavity is made into, within, or occurs in an already existing item and a formulation is applied in the cavity. In this case, the manufactured or created cavity would become the composition housing. As used herein, “cavity” refers to a hollowed out space, indentation, pit, recess, dint, depression, dent, hole, concavity, indenture and the like. For example, a cavity can be created in a natural log using a knife and an amount of a repellent formulation may be applied in the cavity and placed outdoors to prevent animals and/or insects from approaching the area around or near the log. A cavity can be created in items such as, but not limited to, tent stakes, logs, sticks, food items, food containers, clay, dirt and the like.

As used herein, a “housing” is any chamber or section of a larger system. To be housed refers to, but is not limited to, the condition where one or more things are contained, albeit not necessarily completely, within a larger container or vessel. “Container” or “vessel” as used herein refers to an object, holder, receptacle, carrier, item and the like. Containers and vessels may house the formulations of the invention; that is they may be created specifically for the purpose of housing a repellent or attractant formulation.

The systems of the invention may be an object that is configured to resemble and/or disguised as an item that blends and/or integrates into its environment. As used herein, “configured to resemble” and “disguised as” refers to an object that is made to appear as, is similar to, takes on a false appearance of, is camouflaged as, and the like, that may occur in the environment in which the object is placed. As used herein, “blends” and “integrates into” refers to the ability of an object to appear natural or normal or native, incorporate, merge, mingle, assimilate, combine, coordinate, unite, and the like, with its environment.

Devices and means for application of the formulations as pest management systems include, but are not limited to, plant pots, plant pot saucers, vases, door jams, buckets, cans, pans, glass bottles, plastic bottles, used household container items, food container, any empty container, food items, articles of clothing such as socks, stockings, and the like, cardboard or degradable boxes, paper, newspaper, books, deck of cards, logs, rocks, outdoor equipment such as tents, tent stakes and the like.

A further embodiment is a pest management system which includes a signal to alert that a pest has been captured in or come close to the device. “Signal” as used herein refers to a sign, indication, indicator, gesture or object that conveys a notice to a person. A “signal” can include, but is not limited to, a flag, sound, motion, and the like. For example, a device may be a container configured to resemble a log with a compartment inside the log housing an attractant formulation and an opening to allow a pest to enter the device. Once a pest enters the device, the pest triggers a mechanism that closes the opening and the same or another mechanism causes a signal, such as a flag, to rise out of the device.

Formulations which function in a timed-release, extended release and/or controlled release manner are also contemplated by the present invention. As used herein “time release” or “timed release” refers to a composition which exerts its effect over a period of time. The period of time may be in measured in days, weeks or months. “Extended release” refers to compositions which have been formulated to exert their effects over an extended period of time. Extended release compositions are by definition time-release compositions. Extended release compositions are those which exert their effects over a period of time greater than one week. As used herein “controlled release” means the liberation of the repellent composition of the invention into the intended environment in a regular manner or pattern. Controlled release formulations are often timed release formulations although the amount released in any one time across a gradient may vary.

Controlled release formulations in polymeric vehicles have been used for delivery of pesticides, insecticides, fertilizer, detergents, perfumes and in drug delivery. U.S. Pat. No. 5,017,377 to Sikinama et al. discloses a controlled release insect pest repellent including p-menthane-3,8-diol blended with an ethylene vinyl acetate copolymer.

Controlled release formulations of the present invention can be formulated using either non-degradable or degradable materials. In one type of polymeric delivery system, a polymeric capsule is formed around or incorporating the agent to be delivered. The type of agent being delivered and the environment in which the agent is intended to be used determine the composition of the polymer or polymers used and the method that can be used to incorporate the agent. Alternatively, the polymer can be in the form of a sheet, pellets, a film, or a shaped article.

Examples of controlled release devices and methods are disclosed in “Controlled-Release Delivery Systems for Pesticides” edited by Herbert Scher, 1999 CRC Press.

Timed release formulations of the invention may be prepared in any of several ways. They may be prepared and coated onto, contained within or encapsulated in a physical container, granule, polymer, substrate or barrier which breaks down, corrodes or erodes to release the repellent. When formulated in this manner, the granule, substrate or barrier composition need not be homogeneous in size or content. Hence the time release can be controlled by the size or make-up of the material or materials used as a substrate.

They may also be encapsulated within a coating or chemical layer which, upon contact with water, oxygen, or other environment, chemically reacts to dissolve or degrade the coating or layer thereby releasing the repellent.

Where encapsulation of a repellent formulation is desired, such as where the formulation is to be used in a time release manner or where direct contact with the repellent composition is undesirable, compression within a tablet or cake or containment within a capsule may be employed.

In the tablet/cake embodiment, the tablet formulation may comprise multiple layers comprising a different concentration of formulation in each. Layers may be the same size or vary in size based on the amount of formulation to be released. For example, a binary base formulation, with no additional ingredients may be used in the outer layer or layers for an early concentrated release of repellent while a more dilute formulation having longer release characteristics may be contained deeper within the tablet for extended release effect. In this embodiment, tablets or cakes may be formed in any shape or size suitable to the application. It is well within the skill of one in the agricultural art to form tablets or cakes.

For encapsulation, any number of biodegradable polymers or substrates may be used to surround an effective amount of repellent. The repellent compositions of the present invention may be encapsulated into a matrix by the methods disclosed in U.S. Pat. No. 6,500,463, the contents of which are incorporated herein by reference in their entirety. They may also be incorporated into hydrophobic thermoplastic polymers such as those described in U.S. Pat. No. 6,852,328 to form controlled release matrices. U.S. Pat. No. 6,852,328 is herein incorporated by reference in its entirety.

The repellent compositions of the present invention may also be formulated in hydrogel microbeads each comprising a plurality of active material droplets entrained within a hydrophilic matrix that is cured chemically as disclosed in U.S. Pat. No. 6,793,937, the contents of which are incorporated herein by reference in their entirety.

The repellent compositions of the present invention may be incorporated into inorganic polymer complexes for controlled release as in U.S. Pat. No. 6,391,336; employed in granulation methods alone or as an additive as in the methods of U.S. Pat. Nos. 6,331,193 and 6,299,663; combined with insecticidal proteins such as by the methods disclosed in U.S. Pat. No. 6,221,649 and 6,110,463; incorporated into biodegradable plastic products made of coconut mesocarp as disclosed in U.S. Pat. No. 6,083,621; combined with microencapsulated phase change materials such as those described in U.S. Pat. No. 6,057,266 to improve time release; may be incorporated into coated granular pesticide formulations such as those disclosed in U.S. Pat. No. 6,036,971; incorporated into the time release systems described in U.S. Pat. No. 6,004,572; encapsulated in thermoplastic resins such as those described in U.S. Pat. No. 5,679,129; layered into slow release granules such as those in U.S. Pat. No. 4,971,796; or adsorbed in organoclay controlled release formulations such as those disclosed in U.S. Pat. No. 4,849,006, the contents of each patent of which is incorporated herein by reference in its entirety.

Repellent formulations may also be formulated as granular beads or particles for use in post-sale encapsulation by the consumer. In this regard, the repellent formulation may be manufactured such that it may be poured into any fabric or wrapped in a material such as a stocking, sack, sachet, bag, garbage bag and the like. These allow the formulation to be hung or elevated. Alternatively, kits may be provided which include the formulation in combination with a means for application of the time release formulation.

The geraniol based repellent compositions of the present invention may by applied using global positioning system (GPS) technology as disclosed in U.S. Pat. No. 6,199,000, the contents of which is incorporated by reference herein in its entirety.

The compositions of the present invention may be applied or delivered using osmotic devices such as those described in U.S. Pat. No. 6,491,949, the contents of which are incorporated herein by reference in their entirety.

Controlled delivery of the repellents of the present invention may be to a body of water such as is disclosed in U.S. Pat. Nos 5,902,596, 5,885,605 and 5,858,384, the contents of each which are incorporated by reference in their entirety.

They may also be formulated for controlled release on land by incorporation into superabsorbent polymers such as those described in U.S. Pat. No. 4,983,390, the contents of which are incorporated by reference in their entirety. Time release may be effected via wicking of the repellent into the atmosphere. As used herein “wicking” is the process by which the repellent composition is moved via capillary action up a tube or along a material. In the present invention, the repellents may be formulated in candles or simply placed in a container with one or more materials used to “wick” the repellent out of the container into the atmosphere. Wicking can be facilitated or non-facilitated. Facilitated wicking occurs via the use of one or more external energy sources such as via the application of heat or use of a fan or both. Non-facilitated wicking occurs naturally in the absence of any applied external energy source, e.g., evaporation.

Time release may be effected by the direct application of heat to either the repellent alone or to the container in which the repellent is placed.

Time released repellent formulations may be placed around or inside buildings, garden areas, vineyards, turf areas, sports fields, parks, campsites, barns, farms, greenhouses, hung on stands or trees and the like. These may also be placed along side roads or other throughways such and walkways and entrances to limit animal entry. They may also be installed on or within vehicles such as under the hood to deter or prevent animal collision.

In one embodiment time release devices include porous bodies or other bodies that can contain a repellent composition and release the composition over time. One such device is a tube with a permeable wall. The tube is filled with a repellent composition such as, but not limited to, a repellent composition of the present invention. The tube is then used to form a boundary. For example, a garden prone to pests may be protected by placing the time release device around the garden. The device may be surface positioned or buried. The effect of the time release device is to deter insects and/or birds.

An exemplary container includes a formulation that comprises a repellent composition of the present invention wherein the container allows for time release of the formulation over a period of one month or more.

Patterned applications are also contemplated. Such applications may be in any shape or may be random. Application may occur in a circular, radial, oval, square, oblong or any other geometric shape necessary to effect coverage of the intended surface, area or substrate. Coverage of the repellent need not be complete or uniform in order to be effective. Coverage levels may be titrated based on the needed repellent effect. For example, coverage may be at the level of at least 10%, at least 20%, at least 30%, at least 40%, at least 50%, at least 60%, at least 70%, at least 80%, at least 90%, at least 95% or 100%.

Depending on the intended use of the repellent composition, it may be applied to any number of surfaces or substrates or areas and for a wide variety of uses. It is also understood that the repellent compositions may be applied to one or more intermediate surfaces or substrates prior to or to facilitate application to the ultimate or final surface or substrate. For example, the compositions may be applied to a brush in order to then be painted onto a surface.

The geraniol-based repellents of the present invention may also be mixed or combined with other repellents, ingredients, foodstuffs, seeds, treatments, therapeutics (whether for plants or animals) or other agricultural or commercially beneficial products. The repellent compositions of the present invention are also useful in combination with feeding or foodstuffs, whether animal or plant. To this end the repellent compositions may be formulated in combination with the foodstuffs of pests to be repelled or attracted. For example, they may be combined with bird seed, animal feed, livestock feed, and the like. They may also be combined with plant foods such as fertilizers and the like.

They may be mixed with paint or stains or other coatings either in a prepackaged form or as an additive.

They may be used as, or in combination with, a seed or root treatment. The repellents of the present invention may be employed in the protection of seeds or seedlings via a dipping and drying process as described in U.S. Pat. No. 4,058,067, the contents of which are incorporated herein by reference in their entirety.

The geraniol-based repellents of the present invention may be injected into the soil in the form of a liquid or integrated with smoking agents for dispersion underground. In one embodiment, the repellent compositions of the present invention are applied using a fumigation device such as a smoker or fogger. In this application, the compositions may be distributed into the air or into an opening or orifice or point of ingress or egress of one or more pests such as a cave or tunnel or hole.

The repellent compositions of the present invention are useful and may be applied to dwellings, tents, buildings and/or structures, temporary or permanent, commercial and private both inside and outside. They may be used in or on construction or building materials such as siding, lumber or insulation. In one embodiment, the compositions may be impregnated into or within any material. They may be applied to telephone poles, mailbox posts, electricity or power stations, any fenced area (inside, outside or on the fence or containment structure, including on electric fences) or any structure where pests may frequent or be found unwanted. They may be applied to stationary or moving structures, such as machines, farm equipment, motorized vehicles, campers, wagons, all terrain vehicles (ATVs), motorcycles, scooters, golf carts (including the seats or seating covers),watercraft including boats, rafts, and jet skis and the like. The compositions may be formulated for all-season or specific season use and for climates including wet, dry, arid, cold, frigid, tropical, temperate, humid and the like. For example, repellent compositions useful in repelling insects in tropical climates may be formulated with one or more preservatives to combat fungal or bacterial growth fostered by this climate. Likewise, repellent compositions formulated for climates suitable for deer populations may comprise cold-tolerant components or those having lower freezing points such that detection by the animal is still possible. In certain instances, when weather conditions are dry, a preservative such as potassium sorbate can be used.

The repellent compositions of the present invention may also be used to deter ingress or egress of animals and/or insects and as such may be applied to sidewalks, paths, trails, eves, window frames, door frames, or any openings or opening covers which afford entry or exit of pests. To be clear, the repellent compositions may be used to deter entry as well as deter exit from a particular area, space, surface or substrate.

The size of the area being treated is somewhat determined by the natural roaming habitat of the animal and/or insect. The repellent compositions have use in large areas of several hundred acres or more, such as, but not limited to, wildlife areas or preserves, farms, nurseries, vineyards and forests. They may also be used in smaller areas such as playgrounds, backyards, athletic fields, gardens, greenhouses, small green spaces inside and outside cities, or in any place where it is desirable to control pests.

In some embodiments the repellent compositions or formulations are applied as a liquid. In some embodiments they are applied as a solid, having first been applied to a substrate or particulate. In one embodiment, the repellent composition is used to coat or treat a particulate and then allowed to dry on the particulate (with evaporation of the solvent). In other embodiments, the repellent compositions are concentrates and are mixed with particulate matter.

In some embodiments it is important to wait before applying water to a treated area. For example, in some instances, it will be beneficial to wait at least 10, at least 20 or at least 30 minutes before contacting repellent treated area or surface with water.

Since the method of application is variable, the amount of the repellent composition applied depends on the needs of the user, e.g., particular application, and the dilution and whether it is being utilized to repel large animals or insects. In one embodiment, a typical application technique would apply one gallon of the diluted concentrate per 4,000 square feet of surface area in a spray. The spray may be fine or coarse.

The repellent concentrate compositions may be diluted with water (or suitable solvent) at a ratio of one part concentrate to 1 to 34 parts water, 1.5, to 25, 5 to 25, 10 to 15 parts water. It is understood that the dilution ratios may be selected to conform to certain standard package sizes. For example a 1:15 dilution of a concentrate if in ounces would produce 16 ounces of fluid on final dilution making the resultant composition less wasteful where a 16 ounce container is to be used. Likewise, a 1:7 dilution would result in a convenient 8 ounce supply. Serial dilutions are also within the scope of the present invention and find usefulness when treating larger areas.

In some embodiments the repellent compositions are diluted immediately prior to use. In other embodiments, they may be diluted well in advance of use.

At a dilution of between 1:5 to 1:15 the formulations taught herein will effectively treat one acre of land. It should be understood that while a tract of land having an area of one acre may be considered a precise value, the nature of the invention allows for more flexibility in the interpretation. For example, 43,000 square feet is approximately one acre and this would be understood by those of skill in the art and falls within the invention.

Prior to application to trees, plants, grass, water, walks, turf, parking lots, in and around buildings, and the like, the repellent composition may be diluted at the time of use for repelling large animals to one part of repellent to approximately 2 to 34 parts water, preferably 5 to 25 parts water, most preferably 6 to 12 parts water. The mixture is stirred until a uniform composition is obtained.

In the preparation of wettable powders, dust or granulated formulations, the repellent composition is dispersed in and on an appropriately divided carrier. In the formulation of the wettable powders the dispersing agents taught herein can be included.

The repellent compositions of the present invention may be used in the impregnation and or coating of tapes (adhesive and non-adhesive), ribbons, cloth, patches, garbage bags, netting, (e.g., mosquito netting) any fabric or flexible article of manufacture. They may be applied to or impregnated in wet-wipes such as those disclosed in U.S. Pat. No. 7,605,096 the contents of which are incorporated herein in its entirety. Materials onto or into which the repellent compositions are applied may be made of natural or synthetic fibers and may be biodegradable. Biodegradable substrates are advantageous where the repellent will be used in larger spaces and may not be revisited again by the user.

Materials onto which the repellent compositions are applied may also be fluorescent, have fluorescent properties or fluorescent materials applied, or have light emitting properties, whether natural or electronically derived. This combination provides a unique advantage when it is necessary to identify the boundaries of applications or determine where applications have occurred. It also serves to reduce waste.

For example, the repellent formulations may be used to impregnate or coat a ribbon of any suitable material of a width of ¼″ to 3″ or more, preferably ½″ to 1″, and placed around the area to be protected. For this application, dilutions of 1:15 to 1:25 may be used and applied at the rate of one quart of formula to approximately 1200 feet of ribbon. The ribbon is placed above the ground appropriate to the species of animal it is sought to repel, but generally at a height of 6 inches to 4 feet above the ground.

As an alternate procedure, the composition can be impregnated into or coated onto a surface to be protected. In this embodiment, a thickener or thixotropic agent is added to the composition.

In another embodiment, the repellent formulations of the present invention may be combined with the urine or one or more animals such as is disclosed in US pre-grant publication number US20100260862 entitled “Time release formulations and methods of making same” the contents of which are incorporated herein by reference in their entirety. The dot delivery apparatus and systems disclosed in US 20100260862 may also be employed using the composition of the present invention.

As an alternate procedure, the composition can be impregnated into crushed eggshells, nutshells or corncobs, wood chips, clay structures (such as clay balls, clay sheets, clay bricks, clay boats, or any other geometric shape), wood based cellulose granules, agglomerized cellulose or other particulate substrates and spread evenly over the area to be protected. For example, in order to produce a sustained release formulation, the repellent compositions of the present invention may act as the “pest control agents” in the compositions disclosed in U.S. Pat. No. 7,846,463, the contents of which are incorporated herein by reference in their entirety.

It should be clear that the particle size of these materials can vary. Particle size may range from dust sized particles to approximately 1 foot in diameter. In one embodiment, particulate substrates are heterogeneous in size and range from the size of a kernel of corn to that of standard wood chips. In one embodiment particulate substrates are from about 1 inch to 10 inches, 1 inch to 5 inches, 1 inch to 3 inches, or approximately 2 inches. Typically 1 to 10, 1 to 5, or 1 to 3 ounces of concentrated formula is used to wet 1 pound of granular or particulate material. In another embodiment, the particulate substrates may be soaked in either a concentrated formula or one which has been diluted according to the invention. Once dry, the 1 pound of granular or particulate product can be applied to 1000 square feet of surface area. Depending on the desired coverage, more than one application may be made.

In another embodiment, the composition can be left in containers which are distributed in a uniform manner around the area being treated.

Various types of solid materials may be protected by the disclosed repellent compositions. Plant material, including woody plants may be protected from browsing animals. Plant material including grasses, may be sprayed to prevent insects from alighting on the plant.

Exterior surfaces of buildings, walls, concrete and asphalt and other solid non-living surfaces may be sprayed to prevent animals from alighting on, approaching or otherwise contacting such surfaces.

The repellent formulations may be applied to clothing or other fabric or sheet goods to prevent insects from alighting on the material or biting through the material. The fabric may be permeable or impermeable and may be woven or non-woven. Examples of materials to which the compositions may be applied are cottons and other natural fibers or synthetic fibers or sheet goods such as nylon, polyester or polypropylene. If the material is permeable the composition may be absorbed; if impermeable the composition will act as a coating on the surface of the fiber or sheet goods. In one embodiment, the repellent compositions may be mixed in a paper slurry and pressed into paper sheets such as napkins or tablecloths for outdoor use to deter insects. Paper products made in this way may be used to wrap around plants (stems, trunks or other parts) or cover physical structures to deter pest ingress or egress. They may also be mixed in screen printing fluids and printed onto articles of manufacture such as shirts or any fabric amenable to screen printing.

The formulations may be applied to articles of adornment such as jewelry or bands such as wrist bands, hats, caps or any head covering, covering for the hands such as gloves or mittens, as well as shoes, boots, waders, suspenders and the like. They may also be incorporated into systems having butane heated cartridges such as those designed to emit odors to ward off pests. The formulations of the present invention may be used in personalized pest repellent devices such as those worn around the neck, wrist, waist or ankle or those attached to clothing. The personalized pest repellent devices may be motorized or they may be passively activated. The motorized devices may depend on battery or solar power to run the devices. The personalized pest repellent devices may attach to a belt, hat, suspenders, backpack, purse, bag, pocket, shoe, boot, pants, shirt or jacket, or hang around the neck, waist, shoulder, or wrist.

The formulations may be applied to or mixed into candles. These candles may be citronella candles or decorative candles. The wax of the candle may be selected from the group consisting of but not limited to carnauba wax, candelilla wax, beeswax, synthetic wax, shellac wax, spermaceti, lanolin wax, ozokerite, bran wax, ceresin wax, bayberry wax, paraffin, rice wax, jojoba wax, soy wax, palm wax, candle gel and a combination thereof.

The formulation may be applied to the skin, fur or pelt of pets and domestic or other animals to minimize insect problems. The formulation may be applied directly to the animal's coat or pelt by spraying, pouring or massaging the liquid formulation into the coat or pelt. Emulsions of polymers comprising the repellents of the present invention may also be used on the skin of animals as described in U.S. Pat. No. 4,783,335 the contents of which are incorporated herein by reference in their entirety. Pet accessories or adornments such as clothing, leashes, tags, or collars may also be treated with the formulations of the invention. Use of the composition on the surface of various farm structures, particularly on surfaces inside barns where animals are kept or milked will minimize insect interference with farm operations and animals. Livestock accessories or adornments such as harnesses, ear tags, saddles, reins, or blankets may also be treated with the formulations of the invention. The repellent compositions of the present invention may be used to improve cultivation methods and employed in methods such as those described in U.S. Pat. No. 6,887,828, the contents of which are incorporated herein by reference in their entirety

The formulation may also be applied to the skin of humans, preferably by spraying or in the form of a gel, cream or lotion. The spray may be in aerosol form or may be pump-spray form.

In one embodiment the repellent compositions of the present invention are transparent.

The following examples are given for purposes of illustration and not by way of limitation. Unless otherwise defined, all technical and scientific terms used herein have the same meaning as commonly understood by one of ordinary skill in the art to which this invention belongs. Although methods and materials similar or equivalent to those described herein can be used in the practice or testing of methods featured in the invention, suitable methods and materials are described below. The present invention is illustrated further by the following non-limiting Examples.

### EXAMPLES

### Example 1

### Repellent Formulations for Outdoor Use

An animal repellent concentrate for outdoor application is made by mixing the described concentrate of Formulation A, B or C of Table 3 with water as follows:

When added to water in the ratio of one (1) part concentrate with one and a half (1.5) parts water and sprayed onto hard surfaces, either indoor or outdoor, including garbage receptacles, the formulation is useful to repel large animals. Such animals include those traditionally found outside such as dogs, cats, deer, bears and the like.

Depending on the desired coverage, the above formulation may be as dilute as one (1) part concentrate with up to twenty (20) parts diluents (preferably water).

### Example 2

### Application to Hard Surfaces

An animal repellent concentrate of Formulation A, B or C is added to water at the ratio of one (1) part concentrate with nine (9) parts water and applied to hard surfaces and grass areas will repel Canadian geese and blackbirds from surfaces treated. One (1) gallon of this diluted mixture will treat a one (1) acre area. This mix will also kill aphids, caterpillars, and the like.

### Example 3

### Applications to Plants

When added to water at the ratio of one (1) part concentrate of Formulation A, B or C to nineteen (19) parts water and applied to plant foliage, the formulations will repel such animals as deer, rabbit, and the like from feeding on them. This can also be sprayed onto a ribbon of and placed thirty (30) inches above ground around plants to keep deer from entering the area and eating plants. In this embodiment, one preferred ribbon would be ¾ inches wide of made of any suitable material and length necessary.

### Example 4

### Thickenin

To increase the concentration or amount of repellent applied in a defined area, or to control specific applications a formulation having a thicker consistency may be necessary. Thicker formulations may be prepared by the addition of xanthan gum. For example, the quantity of repellent formulation A, B or C (in concentrated or diluted form) may be mixed with approximately 0.5 ounce xanthan gum as a thickener.

### Example 5

### Adherence Modifications

To increase adherence, a repellent formulation A, B or C (in concentrated or diluted form) is mixed with approximately 2 ounces of kaolin clay powder per gallon of concentrate formulation A, B or C, to act as a sticker, to aid in the adherence of the formulation to the surface to be treated.

### Example 6

### Admixtures with Eggshells

A solid formulation of the animal repellent is formed by admixing 1 pound of crushed eggshells with about 1.25 fluid ounces of the animal repellent formulation A, B or C (in concentrated or diluted form), drying the repellant particle and evenly distributing the repellant over the area to be protected.

### Example 7

### Admixtures with Granular Material

A solid formulation of the animal repellent formulation is formed by admixing about 1 pound of granular or particulate material such as corncobs with about 1.25 fluid ounces of the animal repellent formulation A, B or C (in concentrated or diluted form) and drying the repellant particle and evenly distributing the repellant over the area to be protected.

### Example 8

### Admixtures with Nutshells

A solid formulation of the animal repellent formulation is formed by admixing about 1 pound of crushed nutshells with about 1.25 fluid ounces of the animal repellent formulation A, B or C (in concentrated or diluted form), drying the repellant particle and evenly distributing the repellant over the area to be protected.

### Example 9

### Repellent-Coated Particulates

A solid formulation of the repellent formulation A, B or C is prepared by mixing about one pound by weight of crushed eggshells, nutshells, or corncobs granules in a particle size distribution from dustless fine particles to about one-quarter inch overall thickness particles with about 3 fluid ounces of the animal repellent formulation A, B or C (in concentrated or diluted form), drying the repellant particles and evenly distributing the repellant-coated over the area to be protected.

The formulation can also be applied onto a ribbon of any type and size and placed around areas to be protected. For example, it may be applied to a string or rope and hung from any elevation, for example from a tree. One or more coated strips or ribbons may be hung from any one elevated structure.

### Example 10

### Freeze-Dried Repellent Formulation

An animal or insect repellent may be prepared by coating about 4 ounces of formulation A, B, or C onto about one pound weight of straw, hay, seeds, grains, ground corncob, mulch, wood particles and/or compressed wood, and the mixture is then freeze-dried.

### Example 11

### Personal Repellent Apparatus for Humans

An animal or insect repellent to be worn by humans may be prepared where the about one ounce of the liquid formulation of A, B, or C is coated onto an inch-square polymer, cloth, or paper and stored in an apparatus which may attach to clothing, fabric or a person. For example the apparatus can attach to a belt, hat, suspenders, backpack, purse, bag, pocket, shoe, boot, pants, shirt, and/or jacket, or hang around the neck, waist, shoulder or wrist.

### Example 12

### Candle Repellent Formulation

A candle of the animal or insect repellent formulation may be prepared by mixing about three ounces of the repellent formulation A, B, or C and about two ounces of citronella into about a half of a pound of melted soy wax, pouring the wax around a wick, and allowing the wax mixture to dry creating a candle. The candle may be lit so the flame melt the wax and disperse the formulation into the air. The formulation may also be released by using a warming plate to melt the wax and disperse the formulation into the air.

### Example 13

### Gel Repellent Formulation

A gel of the animal or insect repellent formulation may be prepared by mixing about four ounces of the repellent formulation A, B, or C and about two ounces of citronella into about a quarter of a pound of liquid gel wax and the mixture is poured into a mold to solidify after which the solidified mixture may be exposed to air to disperse the formulation.

### Example 14

### Repellent Formulation for Pets

A liquid formulation of the repellent formulation A, B, or C may be prepared by mixing about two ounces of solvent with about one ounce of repellent formulation A, B, or C. The formulation may be used to coat pet collars, tags, or pet clothing which is then attached to the pet or the liquid formulation may be applied directly to the pets coat by spraying, pouring or massaging the liquid formulation into the coat.

### Example 15

### Liquid Repellent Formulation for Livestock

A liquid formulation of the repellent formulation A, B, or C may be prepared by mixing about four ounces of solvent, preferably water, with about three ounces of the repellent formulation A, B, or C. The formulation may be used to coat harnesses, ear tags, saddles, reins or blankets which may be used on the livestock. The liquid formulation may also be applied directly to the livestock by spraying, pouring or massaging the liquid formulation into the coat or pelt.

### Example 16

### Solid Repellent Formulation for Livestock

A solid formulation of the repellent formulation A, B, or C may be prepared by mixing about one pound of crushed eggshells, nutshells, or corncob granules in a particle size distribution from dustless fine particles to about one-quarter inch overall thickness particles with about 3 fluid ounces of the animal repellent formulation A, B, or C, drying the repellent particles and distributing the repellent particles in barns, stables, pens or other areas where livestock may gather.

### Example 17

### Aerial Application Formulation

A liquid formulation of the repellent formulation A, B, or C may be prepared by mixing about 25 gallons of repellent formulation A, B or C with about 40 gallons of solvent.

It is to be understood that the words which have been used are words of description rather than limitation, and that changes may be made within the purview of the appended claims without departing from the true scope and spirit of the invention in its broader aspects.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention.

All publications, patent applications, patents, and other references mentioned herein are incorporated by reference in their entirety. In case of conflict, the present specification, including definitions, will control. In addition, section headings, the materials, methods, and examples are illustrative only and not intended to be limiting.

1. A desiccant comprising:
geraniol in an amount of from about 0.5 to about 30 weight percent;
mint oil in an amount of from about 0.5 to about 15 weight percent;
mineral oil; and
at least one thickener.

2. The desiccant of claim 1 comprising castor oil.

3. The desiccant of claim 2, wherein said at least one thickener includes at least one of kaolin clay and xanthan gum.

4. The desiccant of claim 3 comprising kaolin clay in an amount of from about 0.1 to about 10 weight percent.

5. The desiccant of claim 3 comprising xanthan gum in an amount of from about 0.1 to about 5 weight percent.
